(19) United States
(12) Patent Application Publication
(10) Pub. No.: US 2020/0256682 A1
(43) Pub. Date: Aug. 13, 2020

(54) METHOD AND DEVICE

(71) Applicant: Continental Automotive GmbH, Hannover (DE)

(72) Inventors: Osvaldo Gonsa, Bad Homburg (DE); Rene Alexander Körner, München (DE)

(21) Appl. No.: 16/651,712

(22) PCT Filed: Sep. 26, 2018
(86) PCT No.: PCT/EP2018/076151

§ 371 Date: Mar. 27, 2020

(30) Foreign Application Priority Data
Sep. 28, 2017 (DE) 10 2017 217 299.1

(51) Int. Cl. G01C 21/32; G06F 16/50; G08G 1/01; G08G 1/09; G06K 9/00

(52) U.S. Cl. CPC G01C 21/32; G06F 16/50; G08G 1/0112; G06F 7/588; G08G 1/0141; G06K 9/00791; G08G 1/091

(57) ABSTRACT

A system for generating and/or updating a digital model of at least one sub-region of a digital map includes on the vehicle-side: one or more sensors for capturing vehicle surroundings data; one or more processors, which are configured to determine updating data of the sub-region of the digital map if an event occurs in the form of a difference between objects in the map data and objects in the surroundings data; a transceiver which is configured to receive a message with a seed for a random number from a backend device; the processors generate a random number based on the seed; the transceiver forwards the updating data with the event and its associated spatial position to the backend device if the vehicle-side database is in a default mode in relation to the spatial position of the event or if the random number exceeds a certain value.

### BACKGROUND

The invention relates to the field of driving assistance systems. The present invention relates in particular to the capture of route data by sensors of a vehicle and transmission of the captured route data to a vehicle-external database.

In order to keep data pertaining to route properties in a database of a backend device, for example for autonomous or semiautonomous driving, relevant, the data need to be regularly brought up to date. Capture of the route properties can be performed by vehicles traveling on the roads that are each equipped with suitable sensors and an apparatus for capturing the geo-position. The captured data can then be sent via a vehicle-to-X communication or a mobile radio connection to a database of the backend device, where they are consolidated to produce a data record that can then be sent to other vehicles, e.g. for a route calculation or the like. The captured data can cause a very large data volume from the vehicles to the backend device when updating data from a plurality of vehicles are transmitted to the backend device. If the backend device already contains a statistically significant, updated and consolidated data record, then this represents a waste of communication resources, since a further increase in the quality of the consolidated data record cannot be achieved by further transfers of data captured by vehicles.

### BRIEF SUMMARY

It is therefore the object of the invention to specify a system for generating or updating a digital model of a digital map, which operates reliably and safely.

This object is achieved by means of a system according to the independent system claims. The dependent claims relate to particular embodiments.

One aspect relates to a system for generating and/or updating a digital model of at least one sub-region of a digital map, wherein a bilateral data processing is performed. A portion of the data processing is carried out in one or more vehicles. Another portion of the data processing is carried out in a backend device. On the vehicle side the system has a vehicle database with vehicle-side map data, which image at least a subregion of the digital map, which is also stored in a server database in the backend device. In addition, on the vehicle side, the system has one or more sensors for capturing data on the vehicle surroundings, and one or more processors which are configured to generate at least one snippet from the vehicle surroundings data. The snippet is a partial model of the digital map, which contains object data from objects in the vehicle's surroundings. It may be a CAD (computer-aided design) model of a, for example, 100 m×100 m large map section, which is computed from a sequence of camera images, for example. In addition, the one or more processors are configured to determine from the snippet updating data of the sub-region of the digital map, if an event occurs in the form of a difference between objects in the map data and objects in the snippet. The event can be, for example, a newly added object in the vehicle surroundings, such as a road blockage or a temporarily erected road sign. On the vehicle side, means of determining a spatial position of the event are also available, for example a GPS receiver for determining the position of the vehicle, or a radar sensor for additionally determining the spatial position of the event relative to the vehicle. On the vehicle side a transceiver is also provided, which is configured to receive a seed from a backend device to generate a random number. The one or more processors are also configured to generate a random number based on the seed. The transceiver is further configured to forward the updating data with the event and its associated spatial position to the backend device, if the vehicle-side database is in a default mode in relation to the spatial position of the event or if the random number exceeds a defined value. The default mode refers to a state of the vehicle-side database in which in relation to a defined spatial position of the vehicle, on the initial detection of an event by a vehicle, the latter transfers updating data to the vehicle database. In the default mode of the vehicle database the event is therefore not yet present in the backend.

In addition, the system comprises a backend device in the backend. This contains a server database with backend-side map data of the digital model, and a transceiver which is configured to receive the updating data from one or more vehicles. In addition, one or more processors are provided in the backend device, which are configured to statistically evaluate the updating data and to perform an update of the backend-side map data depending on the statistical evaluation and to generate a certain number of positive and negative tokens depending on the statistical evaluation. The number of positive tokens can be chosen so that the event is verified by a sufficiently high number of confirmations by other vehicles, so that only data with a correspondingly high confidence value is generated or updated in the server database. The transceiver of the backend device is also configured to forward the positive or negative tokens to one or more vehicles.

The digital model stored in the server database can comprise, in particular, a high-resolution digital map with additional surroundings elements. The digital map is formed at least by a road model, which describes the course of roads and driving lanes, and contains information about the number and course of lanes, curve radii, gradients, intersections, and similar characteristics.

The digital model may comprise, in particular, other static or dynamic surroundings elements. Static surroundings elements refer to information about the position and type of road and route markings, such as stop lines, zebra strips, median strips, lane markings and the like, the presence of roadside buildings, as well as their class and relative or absolute position, information about the position and type of traffic signs, or information about the type and condition of light signal systems or variable traffic signs. Dynamic surroundings elements relate in particular to the position and speed of vehicles. For each parameter, in particular, position and attribute, of a surroundings element, e.g. the position of the traffic sign and the type of the traffic sign, a statistic is defined from a statistically significant number of measurements during a training phase. This statistic can reflect the distribution of measured values around a mean value.

The updating data can be assigned a significance value in the backend device not only in relation to the number of measurements, i.e. transmissions by vehicles, but they can already be assigned a confidence value or a statistical parameter on the vehicle depending on their quality, for example the quality of the vehicle surroundings data. Thus, the quality of the vehicle surroundings data may be lower in bad weather conditions such as fog and heavy precipitation than in good weather conditions, in particular if the vehicle surroundings data consist of a sequence of camera images. The transceiver of each vehicle can be configured to forward the confidence value determined on the vehicle side or the statistical parameter to the backend device as additional data in addition to the updating data.

The backend device can also evaluate the updating data by statistical means alone. The one or more processors of the backend device can be configured to statistically evaluate the updating data based on the number of vehicles that have forwarded the updating data and/or on the number of transfers, and to assign a confidence value to the updating data based on the number of vehicles and/or the number of transfers.

The backend device can in this case incorporate the additional data determined on the vehicle side into the determination of the confidence value. The one or more processors of the backend device can evaluate the updating data based on the number of vehicles which have transmitted the updating data, and/or on the number of transfers, and on the basis of the additional data.

One aspect of the system concerns the generation of positive and negative tokens in the backend device. The one or more processors of the backend device can be configured to generate positive and negative tokens if the updating data have a statistical significance that exceeds a minimum threshold value, wherein the positive and negative tokens are assigned at least the spatial position of the relevant event and an event ID of the relevant event. The transceiver device of the backend device can be configured to forward the positive and negative tokens to one or more vehicles, in particular using a broadcast.

One aspect of the system relates to the treatment of the detection of the discontinuation of the event. The discontinuation of the event, to the extent that it can be evaluated as statistically significant, should ensure that all positive and negative tokens in all vehicles with respect to this event are deleted and that with respect to this event, i.e., in particular its spatial position, the vehicle database is transferred back into the default mode.

The one or more vehicle-side processors are configured to detect the discontinuation of the event with a certain spatial position and associated event ID if a negative difference exists between objects in the map data and objects in the snippet. The vehicle-side transceiver can be configured to communicate the discontinuation of the event to the backend device in the form of updating data if a negative token is present in the vehicle-side memory. This means that the discontinuation of the event is only reported by vehicles whose vehicle database has a negative token with respect to this event.

The one or more processors of the backend device can be configured to generate a message to transfer the vehicle-side database into the default mode with respect to the spatial position and event ID of the event which has been discontinued, if the updating data have a statistical significance that exceeds a minimum threshold value. The transceiver of the backend device can be configured to forward the message to one or more vehicles. Thereupon, one or more vehicle-side processors can remove positive or negative tokens with respect to the spatial position and/or event ID from the vehicle-side memory and transfer the vehicle database back into the default mode with respect to the discontinued event.

One aspect relates to the spatial distribution of positive and negative tokens to the vehicles. The transceiver of the backend device can be configured to forward the positive or negative tokens to one or more vehicles, which are only located within the spatial proximity of the event.

One aspect relates to the distribution of the updated map data on the backend side to vehicles. For this purpose, the one or more backend-side processors can be configured to update the server database with backend-side map data of the digital model with the updating data, if this has a confidence value that exceeds a minimum threshold value. The backend-side transceiver can be configured to forward at least the data from the updated database which is related to the event to vehicles located in spatial proximity to the event.

### BRIEF DESCRIPTION OF THE FIGURES

The invention will be described below on the basis of exemplary embodiments with reference to figures. In the figures:

FIG. 1 a block circuit diagram of a system for generating a digital model; and

FIG. 2 a flow chart of the method for the occurrence of an event; and

FIG. 3 a flow chart of an alternative method for the occurrence of an event.

### DETAILED DESCRIPTION

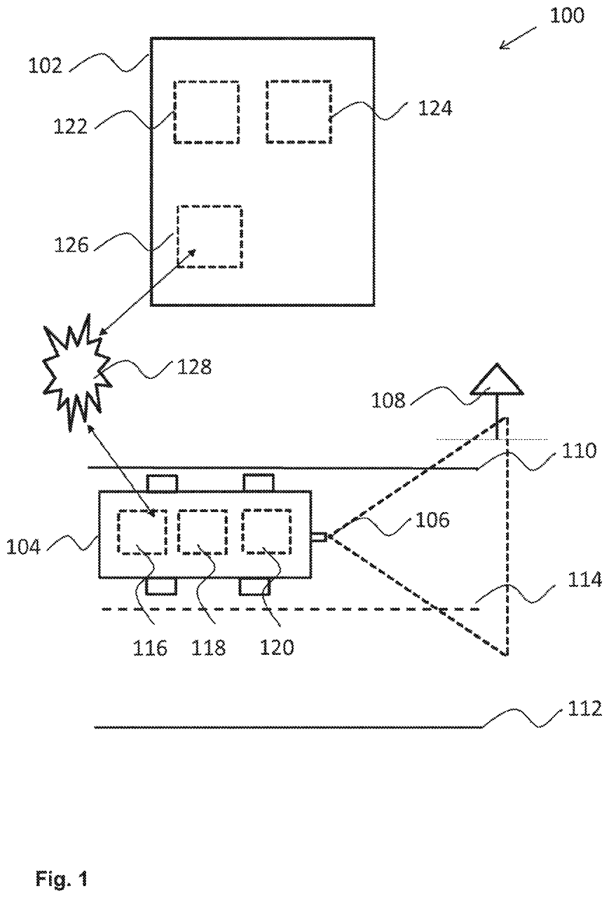

FIG. 1 shows a system 100 for generating and/or updating a digital model of a digital map, the system consisting of a backend device 102 and a vehicle 104 having a sensor 106, which is moving on a road bounded by two lane markers 110, 112 with a median strip 114. The vehicle 104 has a transceiver device 116 for data transfer to or from the backend device 102. The backend device 102 also has a transceiver 126 for data transfer to and from the vehicle 104. The one surroundings sensor 106 mounted on the vehicle 104 can be designed as a camera, and to capture vehicle surroundings data in the form of a sequence of pictures from the vehicle surroundings which include the traffic sign 108. The surroundings sensor can additionally be designed as a radar sensor and configured to scan the surroundings by means of radar. In this way, the radar sensor 106 can additionally determine the position of a surroundings element, such as the traffic sign 108, relative to the spatial position of the vehicle. In conjunction with a GPS module (not shown) the absolute spatial position of the vehicle can also be determined. The vehicle additionally has a processor 120, which is configured to generate a snippet from the vehicle surroundings data. A snippet is an approximately 100×100 m large portion of the digital model and essentially represents an object modeling. The vehicle 104 also has a vehicle database 118 with vehicle-side map data, which image at least a sub-region of a digital map. The processor 120 is configured to compare the snippet with the corresponding vehicle-side map data from the vehicle database 118, to determine whether an event exists in the form of a difference between objects in the map data and the objects in the snippet. In this case, assume that the traffic sign 108 is not yet present in the map data, e.g. because it was only recently installed. The comparison therefore produces the newly installed traffic sign 108 as an event. This event is currently not known to the backend device, as it has not yet been communicated to the device via the communication network.

The vehicle 104 forwards the event in the form of updating data to the backend device 102, which can thereby update its server database 122 with server-side map data of the digital model. The digital model can be assembled from snippets that can originate from a plurality of vehicles. It can also be a parameterizable surroundings model. The parameterization can be performed in the course of a learning process by a statistically significant number of vehicles. The parameterized surroundings model therefore represents vehicle surroundings information consolidated in the backend. Each surroundings element of the surroundings model can have its own statistics in relation to position, attributes and detection probability. The backend device has a processor 124, which is configured to statistically evaluate the updating data and to perform an update of the backend-side map data in the server database 122 depending on the statistical evaluation.

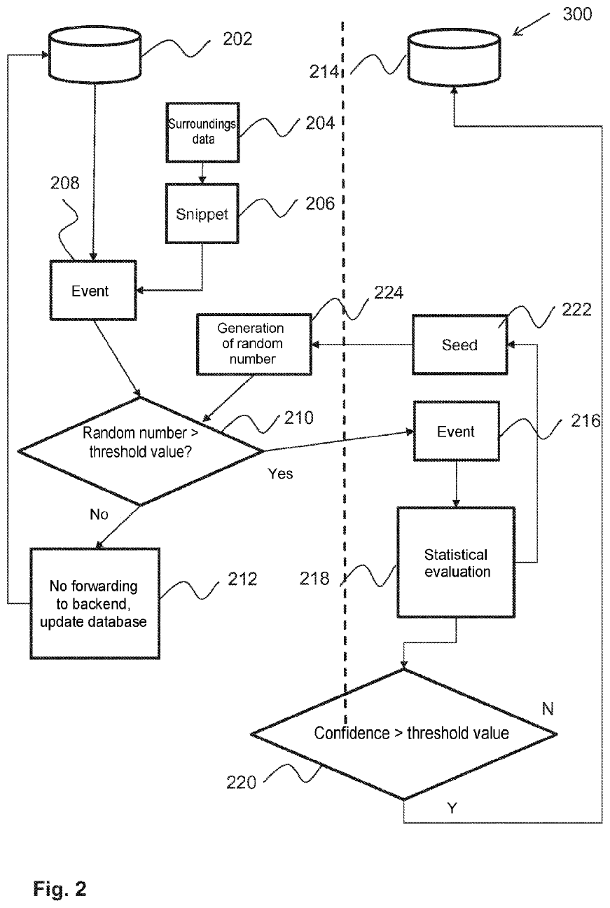

It is assumed that the traffic sign 108 will be passed by a plurality of vehicles. Since each of these vehicles detects the newly installed traffic sign 108 as an event, this would generate a very large volume of data in the uplink to the backend device 102, if this event were communicated to the backend device 102 in the form of updated data by every vehicle. In the following therefore, a token-based protocol for the communication of the updating data is described with reference to FIGS. 2, 3 and 4.

FIG. 2 shows a flow chart 200 of the protocol for the occurrence of an event. In the default mode, for a specific geographic area of the digital map there are no events present yet. The vehicle-side database 202 includes an excerpt from the entire digital map of the server-side database 200. The server-side database 200 contains a surroundings model, in particular a high-resolution digital map with further surroundings elements. The digital map is formed at least by a road model, which describes the course of roads and driving lanes, and contains information about the number and course of lanes, curve radii, gradients, intersections, and similar characteristics. The surroundings model may comprise, in particular, other static surroundings elements. Static surroundings elements refer to information about the position and type of road and route markings, such as stop lines, zebra strips, median strips, lane markings and the like, the presence of roadside buildings, as well as their class and relative or absolute position, information about the position and type of traffic signs, or information about the type and condition of light signal systems or variable traffic signs.

A vehicle-side sensor captures vehicle surroundings data, see step 204. From the vehicle surroundings data a snippet is calculated by one or more vehicle-side processors 206. The snippet contains the traffic sign 108, see FIG. 1, which was recently installed. By comparison, i.e. by calculating the difference between the objects in the vehicle-side database 202 and the objects in the snippet 206, the traffic sign 108 is identified as an event. It is determined in step 210 whether for this event, i.e. for the geographical region in which the event occurred, a seed has been received to generate a random number. For spatial regions in which the vehicle-side database 202 for the corresponding geographical region is in the default mode this is not the case, since the event has not yet been forwarded to the backend. In this case, the event 308 is forwarded to the backend device and after receipt exists there as an event 216. On the backend-side, based on the number of transmissions of the event from possibly different vehicles, a statistical evaluation for this event is performed in step 218. On the basis of the statistical evaluation, a message with a seed for generating a random number is generated in step 222. This message with the seed is forwarded to the vehicle, where in step 224 a random number is generated in a processor configured for this purpose. In addition, as part of the statistical evaluation in step 218 a confidence value is determined, which indicates how trustworthy the event is, and then compared with a threshold value in step 220. If the result of the comparison is that the confidence value exceeds a threshold value, an update of the server-side database 224 is performed. With forwarding of the message with the seed, the vehicle-side database reverts from the default mode into an event mode in which the forwarding of the event takes place depending on the random number generated by means of the seed. If the event no longer exists within a predetermined period of time after the receipt of the message, a corresponding message is sent to the backend. Therefore, on the expiry of the predefined period of time the vehicle-side database transfers from the event mode into the default mode.

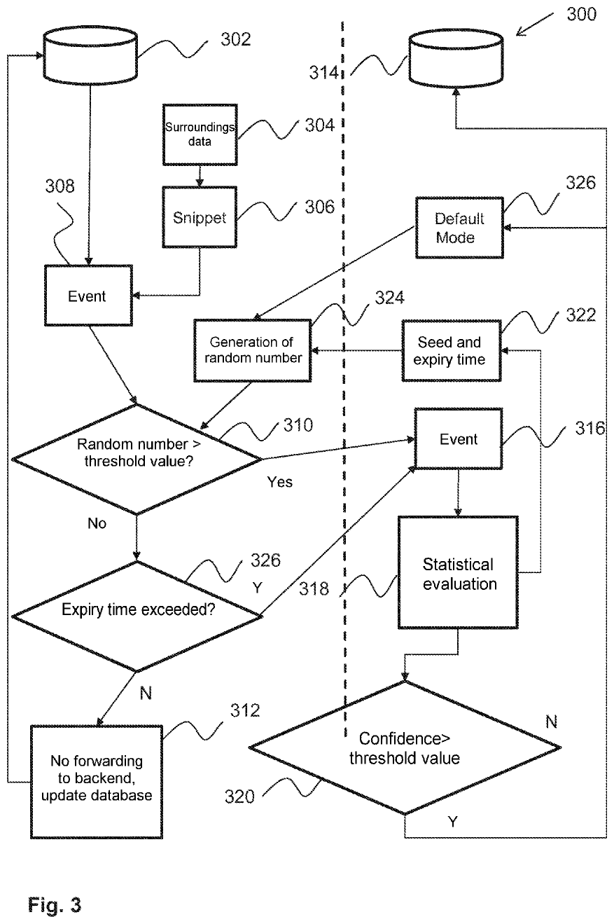

A flow diagram of the protocol of an alternative embodiment is shown in FIG. 3. A vehicle-side sensor captures vehicle surroundings data, see step 304. From the vehicle surroundings data a snippet 306 is calculated by one or more vehicle-side processors. The snippet 306 contains the traffic sign 108, see FIG. 1, which was recently installed. By comparison, i.e. by calculating the difference between the objects in the vehicle-side database 302 and the objects in the snippet 306, the traffic sign 108 is identified as an event. It is determined in step 310 whether for this event, i.e. for the geographical region in which the event occurred, a seed has been received to generate a random number. For spatial regions in which the vehicle-side database 302 for the corresponding geographical region is in the default mode this is not the case, since the event has not yet been forwarded to the backend. In this case, the event 308 is forwarded to the backend device and after receipt exists there as an event 316. On the backend-side, based on the number of transmissions of the event from possibly different vehicles, a statistical evaluation for this event is performed in step 318. On the basis of the statistical evaluation, a message with a seed for generating a random number with an expiry time is generated in step 322. This message is forwarded with the seed and the expiry time to the vehicle, where in step 324 a random number is generated in a processor configured for this purpose. The forwarding can be carried out using a broadcast. For this purpose, the spatial position of the event is mapped onto radio cells and messages are forwarded to the corresponding radio cell.

In addition, as part of the statistical evaluation in step 318 a confidence value is determined, which indicates how trustworthy the event is, and is then compared with a threshold value in step 320. If the result of the comparison is that the confidence value exceeds a threshold value, an update of the server-side database 324 is performed. With forwarding of the message with the seed, the vehicle-side database reverts from the default mode into an event mode in which the forwarding of the event takes place depending on the random number generated by means of the seed. If the event is still present after the expiry period has elapsed, then it is treated as a new event in the default mode. It is therefore forwarded from all vehicles to the backend. For this purpose, in step 326 it is checked whether the expiry time has been exceeded. If this is the case, then regardless of whether the random number exceeds the threshold, the event is forwarded to the backend. Otherwise, only the vehicle-side database 302 is updated.

1. A system for generating and/or updating a digital model of at least one sub-region of a digital map, said system comprising:
a vehicle database with vehicle-side map data which image at least one subregion of the digital map,
one or more sensors for capturing vehicle surroundings data;
one or more vehicle-side processors, which are configured to generate at least one snippet from the vehicle surroundings data, and to determine from the snippet updating data of the sub-region of the digital map when an event occurs in the form of a difference between objects in the map data and objects in the snippet;
means for determining a spatial position of the event;
a vehicle-side transceiver, which is configured to receive a message with a seed for a random number from a backend device;
wherein the one or more vehicle-side processors are also configured to generate a random number based on the seed;
wherein the vehicle-side transceiver is configured to forward the updating data with the event and its associated spatial position to the backend device when the vehicle-side database is in a default mode in relation to the spatial position of the event or if the random number exceeds a certain value; and
the system having a backend device on the backend side, with:
a server database with backend-side map data of the digital model;
a backend-side transceiver which is configured to receive the updating data from one or more vehicles;
one or more backend-side processors, which are configured to statistically evaluate the updating data and to generate the seed depending on the statistical evaluation and to perform an update of the backend-side map data; and
wherein the transceiver is also configured to forward the seed to one or more vehicles.

2. The system as claimed in claim 1, wherein the one or more backend-side processors are configured to statistically evaluate the updating data based on the number of vehicles that have forwarded the updating data and/or the number of transfers, and to assign a confidence value to the updating data based on the number of vehicles and/or the transfers.

3. The system as claimed in claim 2, wherein the one or more backend-side processors are configured to update the server database with backend-side map data of the digital model with the updating data when the latter have a confidence value that exceeds a minimum threshold value, and wherein the backend-side transceiver is configured to transmit at least the data from the updated database which relate to the event and the seed to vehicles by using a broadcast.

4. The system as claimed in claim 3, wherein the vehicle-side transceiver is configured to transmit the updating data with the event with an associated timestamp and wherein the backend-side transceiver is configured to transmit the data of the updated database which relate to the event with the timestamp of the event.

5. The system as claimed in claim 4, wherein the one or more vehicle-side processors are configured to detect the discontinuation of the event with a certain spatial position and associated event ID when a negative difference exists between objects in the map data and objects in the snippet; wherein the vehicle-side transceiver device is configured to communicate the discontinuation of the event to the backend device in the form of updating data when the random number exceeds a value and a specified period of time has not yet been exceeded since the occurrence of the event; and wherein the one or more backend-side processors are configured to generate a message which will transfer the vehicle-side database into the default mode with respect to the spatial position and event ID of the event which has ceased, when the updating data have a confidence value that exceeds a minimum threshold value; and wherein the transceiver of the backend is configured to forward the message to one or more vehicles using a broadcast.

6. The system as claimed in claim 5, wherein one or more vehicle-side processors are configured to transfer the vehicle-side database back into the default mode in relation to the spatial position of the event, when a specified period of time has been exceeded since the occurrence of the event.

7. The system as claimed in claim 3, wherein the vehicle-side transceiver is configured to transmit the updating data with the event with an associated timestamp and wherein the backend-side transceiver is configured to transmit the data of the updated database which relate to the event with an expiry time.

8. The system as claimed in claim 7, wherein the one or more vehicle-side processors are configured to detect the discontinuation of the event with a certain spatial position and associated event ID when a negative difference exists between objects in the map data and objects in the snippet; wherein the vehicle-side transceiver is configured to communicate the discontinuation of the event to the backend device in the form of updating data when the random number exceeds a value and the expiry time has not been exceeded; and wherein the one or more processors of the backend device are configured to generate a message which will transfer the vehicle-side database into the default mode with respect to the spatial position and event ID of the event which has ceased, when the updating data have a confidence value that exceeds a minimum threshold value; and wherein the transceiver of the backend is configured to forward the message to one or more vehicles using a broadcast.

9. The system as claimed in claim 8, wherein one or more vehicle-side processors are configured to transfer the vehicle-side database back into the default mode in relation to the spatial position of the event when the expiry time has been exceeded.

10. The system as claimed in claim 9, wherein the broadcast takes place via TMC or LTE.
